(19) United States
(12) Patent Application Publication
(10) Pub. No.: US 2005/0046154 A1
(43) Pub. Date: Mar. 3, 2005

(54) Inflatable curtain mounting bracket

(76) Inventors: Scott L. Rhea, Albion, IN (US); Brian Powals, Waterford, MI (US)

Correspondence Address: Sally J. Brown;AUTOLIV ASP, INC., 3350 Airport Road, Ogden, UT, 84405, US

(21) Appl. No.: 10/654,380

(22) Filed: Sep. 3, 2003

(51) Int. Cl. B60R 21/22

(52) U.S. Cl. 280/728.2; 280/730.2

(57) ABSTRACT

A mounting bracket that may be used to mount an inflatable curtain airbag having a manifold to a vehicle interior is disclosed. The mounting bracket includes a base bracket that has at least one aperture and at least one connecting tab. The mounting bracket also includes a retaining clip that is attachable to the base bracket. The retaining clip has at least one receiving portion and at least one inserting tab. The at least one inserting tab is constructed such that it may be inserted into the at least one aperture. Similarly, the at least one connecting tab is designed to engaged the at least one receiving portion. Preferably, the mounting bracket is constructed such that when the retaining clip is attached to the base bracket, the mounting bracket retains the manifold between the base bracket and the clip.

### BACKGROUND OF THE INVENTION

1. Field of the Invention

The present invention relates to attaching an airbag to the interior of a vehicle. More specifically, the present invention relates to novel mounting bracket that may be used to attach an inflatable curtain airbag having a manifold to an interior vehicle surface.

2. Description of Related Art

Inflatable airbags are well accepted for use in motor vehicles and have been credited with preventing numerous deaths and injuries. In fact, the inclusion of inflatable safety restraint devices, or airbags, is now a legal requirement for many new vehicles. Airbags are typically installed in the steering wheel and in the dashboard on the passenger side of a car. In the event of an accident, an accelerometer within the vehicle measures the abnormal deceleration and triggers the ignition of a pyrotechnic charge. Expanding gases from the charge fill the airbags, which immediately inflate in front of the driver and passenger to protect them from impact against the windshield. Side impact airbags have also been developed in response to the need for similar protection from impacts in a lateral direction, or against the side of the vehicle.

Recently, airbag technology has continued to advance such that curtain airbags are now enlisted to provide roll-over protection as well as side impact protection. During a roll-over accident, the vehicle occupants can be jostled considerably, thereby causing the occupant to impact various parts of the vehicle interior. Even worse, the occupant may be ejected from the vehicle. Alternatively, a head or limb of an occupant may extend outside the vehicle during the roll-over. Such “occupant excursion” during roll-over accidents is a common cause of automotive fatality, particularly in the case of vehicle occupants that are not wearing a seat belt during the roll-over.

Conventional curtain airbags attempt to combat the dangers of side impact or roll-over accidents by having a curtain airbag unroll or unfold downward from the roof of the vehicle and then inflate beside the person as a means of preventing the person from hitting the door or window. Since a vehicle occupant may be leaning forward, reclined in the seat, or at any position in between, such curtain airbags are usually designed to be long enough to cover the whole interior side of the vehicle, protecting occupants in both front and rear passenger compartments.

To provide side impact and roll-over protection, curtain airbags are sized to hold large volumes of inflation gas and descend below the window sill. Consequently, when not inflated, the curtain airbag includes a significant amount of airbag material. Generally, the material is rolled or folded tightly into a long tubular bundle. During the inflation process, the curtain unrolls or unfolds along a side of the vehicle. The curtain may be kept rolled or folded by a sock that fits around the curtain.

Many curtain airbags also include a manifold positioned at or near the top of the airbag. The manifold is a long tube or pipe that spans the length of the curtain. Usually, the manifold is in fluid communication with an inflator such that when the airbag is deployed, inflation gas will flow from the inflator into the manifold. Once the inflation gas enters the manifold, the inflation gas flows through the manifold and is channeled into the inflatable portions of the curtain airbag by one or more holes that are positioned along the manifold's longitudinal length.

The curtain is stored and mounted either on or proximate a roof rail of the vehicle. Such mounting is generally accomplished via a two-step process. First, the curtain must be held in the proper position. This can be done by either having multiple workers hold the airbag or by attaching the airbag to sophisticated jigs, push pins, hooks, or mounting brackets (collectively “brackets”) that have been placed into holes or slots in the body of the vehicle. Once the curtain airbag has been secured in the proper location, the workers are free to affix the curtain airbag assembly to the vehicle using fasteners such as bolts, screws, rivets, and the like. Usually these fasteners are threaded into holes, slits, or apertures that have been put into the top of the curtain airbag to facilitate the assembly process.

Unfortunately, many known mounting brackets have significant disadvantages that have limited the ability of vehicle and airbag manufacturers to implement and use these brackets with airbag systems in which the curtain includes a manifold. Specifically, most known mounting brackets lack a feature that retains or otherwise holds the manifold in the correct position. Without such retention, there is an inherent risk that the manifold will flex or otherwise move during deployment. This movement of the manifold can be extremely detrimental as it can increase the time required to inflate the airbag and/or cause the inflated airbag to become situated in an improper or undesirable position.

In an attempt to overcome these limitations, new mounting brackets have recently been designed such that a portion or section of the manifold may be captured and/or retained within the bracket. While such brackets have represented an improvement in the art, many of these brackets are limited by the fact that they are expensive, costly, and difficult to use. As a result, if airbag manufacturers choose to employ these brackets, the overall tooling, production, and assembly costs of the airbag system are significantly increased.

Moreover, many mounting brackets that are designed to retain a manifold are further limited in that the system or feature that captures the manifold is often very complicated. As a result, the process by which an airbag installer captures a portion of the manifold within these complex features is arduous, time-consuming, and labor intensive. Even working together, it will likely take multiple employees several minutes to install each airbag unit using these known brackets as they will have to position the manifold within the bracket, capture the manifold, and then permanently attach to the bracket and the retained manifold to the vehicle interior. As the manufacturer incurs costs for every moment that passes during the manufacturing process, these several minutes drastically raise the total production costs and reduce the manufacturer's overall profit margin.

Lastly, many known mounting brackets that retain a manifold have a further limitation in that they may not be used with most secondary brackets. Secondary brackets are plates, brackets, or other features that may be used to attach vehicle components including inflators, hardware, pillar ramps, hand grips, lighting fixtures, sun or moon roofs, hanger hooks, wiring, drain hoses, heating and ventilation (HVAC) controls, ducts, and the like to the interior of the vehicle. Unfortunately however, the shape of the most known mounting brackets is incompatible with the shape of these secondary brackets. As a result, before vehicle manufacturers can employ these mounting brackets, they will first be required to expend additional resources in reconfiguring and/or moving the secondary brackets away from the area occupied by the mounting brackets.

Accordingly, there is a need in the art for a novel mounting bracket that addresses and/or solves one or more of the above-listed problems. Such a device is disclosed herein.

### SUMMARY OF THE INVENTION

The apparatus of the present invention has been developed in response to the present state of the art, and in particular, in response to the problems and needs in the art that have not yet been fully solved by currently available mounting brackets. Thus, the present invention comprises a mounting bracket that is designed to attach an inflatable curtain airbag having a manifold to the interior surface of a vehicle.

The mounting bracket comprises two sections or components: a base bracket and a retaining clip. The retaining clip is attachable to the base bracket. Preferably, the mounting bracket is constructed such that when the retaining clip is attached to the base bracket, the manifold is retained or held between the retaining clip and the base bracket.

The retaining clip is constructed such that it includes an inserting tab. More than one inserting tab may also be used. The inserting tab is a flap, extension, or other feature that is constructed such that it is capable of being inserted and/or interlocked with a portion of the base bracket.

A receiving portion is also added to the retaining clip. More than one receiving portion may also be used. The receiving portion is located proximate to the inserting tab. The receiving portion is designed and sized such that it may receive and/or a retain all or a portion of the base bracket. In some embodiments, the receiving portion comprises one or more slits that are designed such that a portion of the base bracket may pass through the slits. Of course, other features that are capable of receiving and/or retaining a portion of the base bracket, including surfaces, tabs, flanges, extensions, and the like may also be used as the receiving portion.

The base bracket is constructed such that it comprises one or more connecting tabs that are designed to engage the receiving portion. This may be accomplished by constructing the connecting tabs such that they may be passed through the slits. In other embodiments, the connecting tabs may be constructed to fold down over the receiving portion. In yet an additional embodiment, one or more fasteners may cause the connecting tabs to engage the receiving portion.

In some embodiments, one or more locking barbs may be added to the connecting tabs. The locking barbs are flaps or extensions that extend either outwardly or inboard of the connecting tabs. Preferably, the locking barbs are constructed such that if the retaining clip is attached to the base bracket, the locking barbs ensure that the connecting tabs remain engaged with the receiving portion.

An aperture is also added to the base bracket. The aperture is a hole or opening in the base bracket that is positioned proximate to the connecting tabs. More than one aperture may also be used. The aperture is constructed and sized to receive the inserting tab. More particularly, the aperture is constructed and sized such that the inserting tab may be inserted and/or interlocked with the aperture.

The mounting bracket may additionally comprise a first hole and a second hole. The first hole is added to the base bracket and the second hole is added to the retaining clip. Preferably, the first hole and the second hole are sized to receive a fastener. More specifically, the first hole and the second hole are sized such that the fastener may traverse the mounting bracket by passing through the first hole and the second hole. In some embodiments, the holes can be sized and/or constructed such that the size of the first hole differs from the size of the second hole in order to accommodate various build tolerances and allow for easier installation of the fastener.

One or more shape maintaining tabs may additionally be added to the base bracket. These shape maintaining tabs are positioned proximate to the first hole. Preferably, the shape maintaining tabs are designed such that when the mounting bracket is attached to a curtain airbag, the shape maintaining tabs hold the curtain airbag in rolled and/or folded configuration.

The base bracket may further comprise a mounting portion. More than one mounting portion may also be used. The mounting portion is a tab, hook, push pin, jig, fastener, or other similar feature that extends rearwards of the first hole and is designed such that it is capable of engaging the vehicle interior Additionally, the mounting bracket may further be constructed to attach to a secondary bracket. As used herein, the term “secondary bracket” are plates, brackets, or other features that may be used to attach vehicle components including inflators, hardware, pillar ramps, hand grips, lighting fixtures, sun or moon roofs, hanger hooks, wiring, drain hoses, heating and ventilation (HVAC controls), ducts, and the like to the interior of the vehicle. Preferably, the mounting bracket is constructed such that it may be attached to the secondary bracket by clinching or otherwise fitting the base bracket into a portion of the secondary bracket.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of a vehicle interior having a curtain airbag with a manifold attached by one embodiment of the mounting bracket of the present invention;

FIG. 2 is a perspective view of the mounting bracket of FIG. 1;

FIG. 3 is a perspective view of the way in which the mounting bracket of FIG. 2 retains a curtain airbag having a manifold;

FIG. 4 is a perspective view of the way in which the mounting bracket of FIG. 2 may be attached to a secondary bracket;

FIG. 5 is a perspective view of a different embodiment of the mounting bracket of the present invention;

FIG. 6 is a perspective view of a further embodiment of the mounting bracket of the present invention;

FIG. 7 is a perspective view showing an additional embodiment of the mounting bracket of the present invention;

FIG. 8 is a perspective view showing a further embodiment of the mounting bracket of the present invention; and

FIG. 9 is a perspective view illustrating yet an additional embodiment of the mounting bracket of the present invention.

### DETAILED DESCRIPTION OF THE PREFERRED EMBODIMENTS

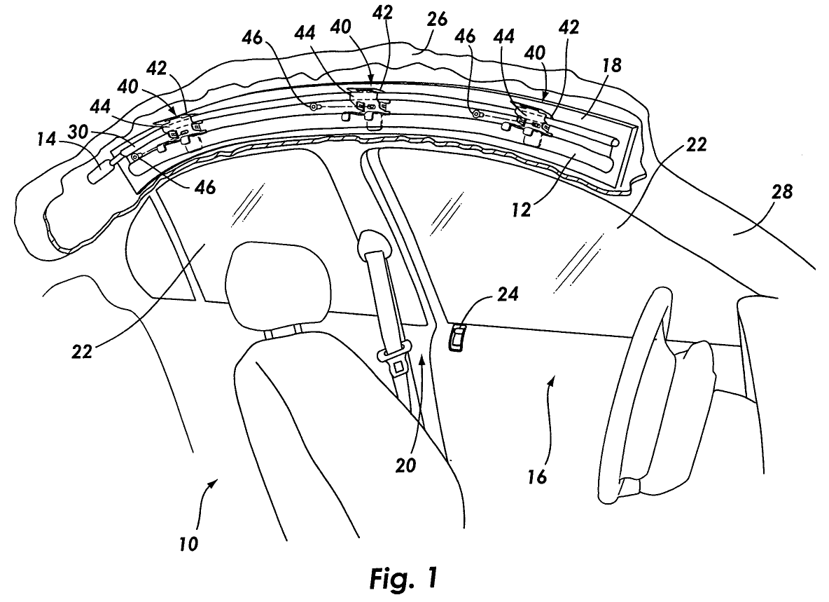

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 9, is not intended to limit the scope of the invention, as claimed, but is merely representative of presently preferred embodiments of the invention.

Referring to FIG. 1, a vehicle interior 10 is depicted with an attached inflatable side curtain airbag 12. The side curtain airbag 12 is attached to an inflator 14 that provides inflation gas to the airbag 12 during an accident. A sensor and/or an ECU (not shown) that provides an initiation signal to initiate inflation of the curtain airbag 12 when an accident occurs is also added.

Generally, the curtain airbag 12 is positioned above the vehicle door 16 along a roof rail 18. The curtain airbag 12 is designed to inflate and substantially cover the door 16, the lateral side 20, the window 22, and the lock switch 24 when an accident occurs. Because the size of the roof rail is generally kept to a minimum to provide an aesthetic vehicle interior and to accommodate larger windows, the curtain airbag 12 is usually folded, rolled or otherwise gathered into a bundle having dimensions similar to those of the roof rail 18, before installation on the vehicle.

As the roof rail 18 and the curtain airbag 12 are often not visually appealing to the customer, a vehicle headliner 26 and/or decorative trim 28 are usually added to increase the aesthetic attractiveness of the vehicle interior 10. The headliner 26 is generally added to cover the roof of the vehicle while the edges of the headliner 26 descend to mask the area inboard of the roof rail. If the design of the vehicle interior 10 is such that the roof rail is not completely covered by the headliner 26, the decorative trim 28 may be used to further cover the roof rail or the curtain airbag 12.

The curtain airbag includes a manifold 30. As described above, the manifold 30 is a hollow tube that spans the length of the curtain airbag 12. Preferably, the manifold 30 is positioned proximate the top of the curtain airbag 12 and is designed such that when the airbag 12 is being inflated, inflation gas produced by the inflator 14 flows into the curtain airbag 12 via the manifold 30. A sock (not shown in FIG. 1) may also be used to encase and protect the airbag 12.

The curtain airbag 12 is secured to the vehicle 10 to ensure that the curtain airbag 12 maintains a preferred position and orientation during deployment as well as during the normal operation of the vehicle. Thus, one or more mounting brackets 40 are added to mount the curtain airbag 12 to the vehicle 10. The mounting brackets 40 are preferably made of metal such as steel or pre-coated steel. However, materials such as aluminum, plastic, and the like that are capable of supporting the curtain airbag 12 may also be used.

The mounting brackets 40 generally comprise two sections or components: a base bracket 42 and a retaining clip 44. The retaining clip 44 is attachable to the base bracket 42 which, in turn, contacts and/or is affixed to the vehicle interior 10. As seen in FIG. 1, the mounting bracket 40 is constructed such that when the retaining clip 44 is attached to the base bracket 42, the manifold 30 is held between the retaining clip 44 and the base bracket 42.

Preferably, the curtain airbag 12 and the mounting brackets 40 are mounted onto the vehicle interior 10 through the use of one or more fasteners 46. The fasteners 46 may be selected from any of the types of fasteners or connectors known in the art, including bolts, screws, rivets, jigs, hooks, nails, clips, and the like. Preferably, the fasteners 46 are constructed to pass through the mounting brackets 40 such that the mounting brackets 40 and the curtain airbag 12 become permanently affixed to the vehicle interior 10.

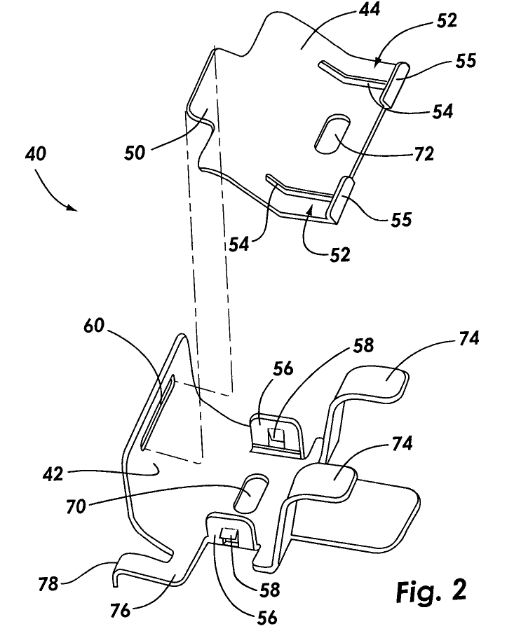

Referring now to FIG. 2, a perspective view of the mounting bracket 40 comprising the base bracket 42 and the retaining clip 44 is illustrated. As can be seen in FIG. 2, the retaining clip 44 includes an inserting tab 50. More than one inserting tab 50 may also be used. The inserting tab 50 is a flap, extension, or other feature that is constructed such that it is capable of being inserted and/or interlocked with a portion of the base bracket 42.

A receiving portion 52 is also added to the retaining clip 44. More than one receiving portion 52 may also be used. The receiving portion 52 is located proximate to the inserting tab 50. Preferably, the receiving portion is designed and sized to such that it may receive and/or a retain all or a portion of the base bracket 42.

In the embodiment shown in FIG. 2, the receiving portion 52 comprises one or more slits 54. The slits 54 are openings or holes in the retaining clip 44 that are sized such that a portion of the base bracket 42 may pass through the slits 54. Of course those of skill in the art will recognize that the receiving portion 52 may take on a variety of different forms, configurations, and/or orientations. In fact, any surface, flange, tab, or other feature that is capable of receiving and/or retaining all or a portion of the base bracket 42 may be used as the receiving portion 52.

The retaining clip 44 may further comprise one or more legs 55. The legs 55 are vertical tabs that are positioned proximate the receiving portion 52. Preferably, the legs 55 are located along an edge of the retaining clip and are designed to extend vertically away from the receiving portion 52.

The retaining clip 44 is attachable to the base bracket 42. This attachment of the retaining clip 44 to the base bracket 42 is accomplished by constructing the base bracket 42 with one or more connecting tabs 56 that are designed to engage the receiving portion 52. As illustrated in the embodiment shown in FIG. 2, the base bracket 42 is constructed such that the connecting tabs 56 engage the receiving portion 52 by passing through the slits 54. Those of skill in the art will recognize that other embodiments may also be made in which the method and manner by which the connecting tabs will engage the receiving portion 52 differs from that which is shown in FIG. 2. For example, embodiments may be made in which the base bracket 42 is constructed such that the connecting tabs 56 may be folded over the receiving portion 52. Yet further embodiments may be constructed in which one or more fasteners cause the connecting tabs to engage the receiving portion 52.

The embodiment depicted in FIG. 2 shows two connecting tabs 56 that extend upwardly from the base bracket 42. Other embodiments may also be made in which the number, orientation, configuration, and/or shape of the connecting tabs 56 differs from that which is illustrated in FIG. 2. For example, embodiments may be made using more than two connecting tabs 56. Other embodiments may employ only one connecting tab 56. Still further embodiments may be made in which the connecting tabs 56 extend laterally or downwardly from the base bracket 42. Yet further embodiments have the connecting tabs 56 be curved, angled, and/or offset with respect to the base bracket 42.

The connecting tabs 56 may additionally comprise one or more locking barbs 58. The locking barbs 58 are tabs or extensions that slant or extend outwardly from the connecting tabs 58. Preferably, the locking barbs 58 are constructed such that if the connecting tabs 56 pass through the slits 54, the locking barbs 58 will engage the retaining clip 44 and prevent the connecting tabs 56 from withdrawing from the slits 54.

An aperture 60 is also added to the base bracket 42. The aperture 60 is a hole or opening in the base bracket 42 that is positioned proximate to the connecting tabs 56. More than one aperture 60 may also be used. The aperture 60 is constructed and sized to receive the inserting tab 50. More particularly, the aperture 60 is constructed and sized such that the inserting tab 50 may be inserted and/or interlocked with the aperture 60.

Referring still to FIG. 2, the mounting bracket 40 may additionally comprise a first hole 70 and a second hole 72. The first hole 70 is added to the base bracket 42 and the second hole 72 is added to the retaining clip 44. Preferably, the first hole 70 and the second hole 72 are sized to receive a fastener 46 (shown in FIG. 1). More specifically, the first hole 70 and the second hole 72 are sized such that the fastener 46 may traverse the mounting bracket 40 by passing through the first hole 70 and the second hole 72.

One or more shape maintaining tabs 74 may additionally be added to the base bracket 42. These shape maintaining tabs 74 are positioned proximate to the first hole 70. Preferably, the shape maintaining tabs 74 are designed such that when the mounting bracket 40 is attached to a curtain airbag 12 (shown in FIG. 1), the shape maintaining tabs 74 hold the curtain airbag 12 in rolled and/or folded configuration.

The base bracket 42 may further comprise a mounting portion 76. More than one mounting portion 76 may also be used. The mounting portion 76 is a tab or other similar feature that extends rearwards of the first hole 70 and is designed such that it is capable of engaging the vehicle interior 10 (shown in FIG. 1).

As illustrated in FIG. 2, the mounting portion 76 comprises a hook 78. Those of skill in the art will recognize that any tab, extension, or other feature that is capable of engaging the vehicle interior 10 may be used as the mounting portion 76. Examples of such features may include T-shaped tabs, push pins, fasteners, jigs, bars, clips, and the like.

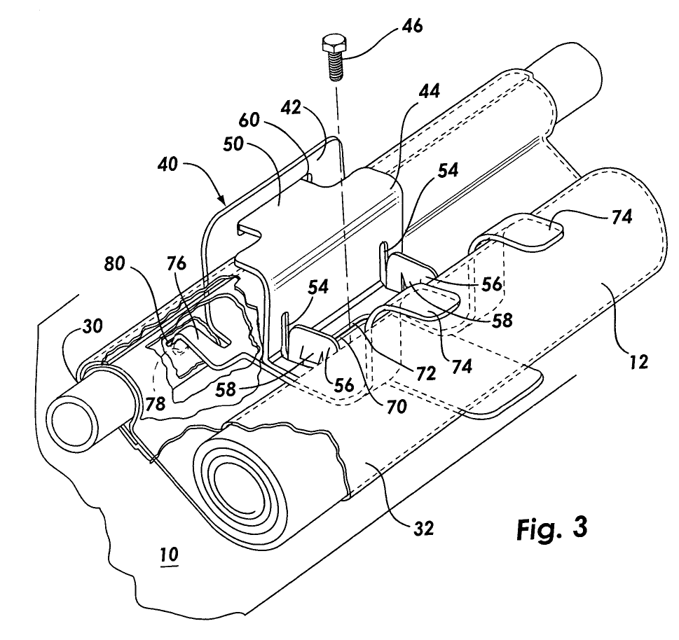

Referring now to FIG. 3, a partially cutaway perspective view of the mounting bracket 40 is illustrated. In FIG. 3, the retaining clip 44 has been attached to the base bracket 42. Such attachment may be accomplished by inserting the inserting tab 50 into the aperture 58 and/or having the connecting tabs 56 engage the receiving portion 52 by passing through the slits 54. Preferably, once the connecting tabs 56 have passed through the slits 54, the locking barbs 58 engage the retaining clip 44 and prevent the connecting tabs 56 from withdrawing from the slits 54.

As can be seen in FIG. 3, the mounting bracket 40 may also retain all or a portion of a curtain airbag 12 having a manifold 30. More specifically, the mounting bracket 40 is constructed such that when the retaining clip 44 is attached to the base bracket 42, the mounting bracket 40 retains all or a portion of the manifold 30 between the retaining clip 44 and the base bracket 42. A sock 32 that encases and protects the airbag 12 has also been illustrated.

Additionally, the shape maintaining tabs 74 may also be used to engage and retain the curtain airbag 12. Preferably, this is accomplished by constructing the shape maintaining tabs 74 to wrap around a portion of the curtain airbag 12, thereby holding and retaining the airbag 12 in a rolled or folded configuration.

FIG. 3 also illustrates the manner in which the mounting bracket 40 may be used to attach or mount the curtain airbag 12 to the vehicle interior 10. Such attachment of the curtain airbag 12 to the vehicle is accomplished via a two-step process. First, the mounting bracket with the retained curtain airbag 12 is positioned onto the vehicle interior 10. In FIG. 3, such positioning of the curtain airbag 12 may be accomplished by engaging and/or inserting the mounting portion 76 into an opening 80 located on the vehicle interior 10. Of course, other methods of positioning the curtain airbag 12 may also be used.

Once the curtain airbag 12 has been properly positioned, the airbag 12 may then be permanently attached or mounted to the vehicle interior 10. Such attachment of the airbag 12 may be accomplished through the use of a fastener 46. More than one fastener 46 may also be used. Preferably, the fastener 46 passes through the holes 70, 72 such that the mounting bracket 40 and the retained curtain airbag 12 become bolted or otherwise affixed to the vehicle interior 10.

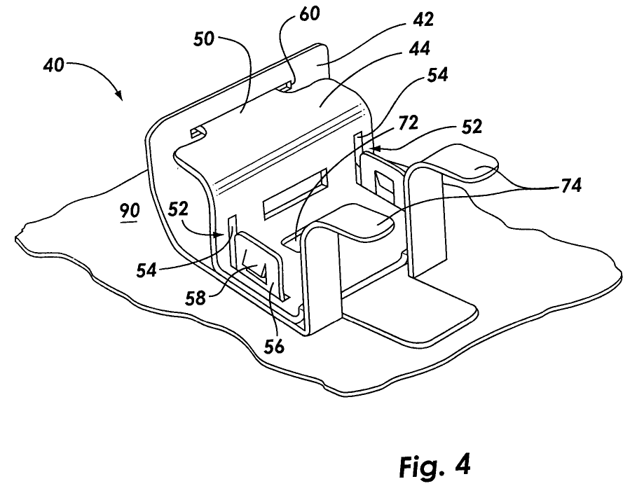

Referring now to FIG. 4, the mounting bracket 40 may be constructed to attach to a secondary bracket 90. As used herein, the term “secondary bracket” are plates, brackets, or other features that may be used to attach vehicle components including inflators, hardware, pillar ramps, hand grips, lighting fixtures, sun or moon roofs, hanger hooks, wiring, drain hoses, heating and ventilation (HVAC controls), ducts, and the like to the interior of the vehicle. As shown in FIG. 4, the secondary bracket 90 comprises a plate. However, other shapes, configurations, and/or orientations of the secondary bracket 90 may also be used.

In the embodiment shown in FIG. 4, the mounting bracket 40 is constructed such that it may be attached to the secondary bracket 90. Such attachment may occur by clinching or otherwise fitting the base bracket 42 into a portion of the secondary bracket 90. Of course, other embodiments may also be made in which the mounting bracket 40 is attached to the secondary bracket via other methods such as through fasteners, welding, and the like.

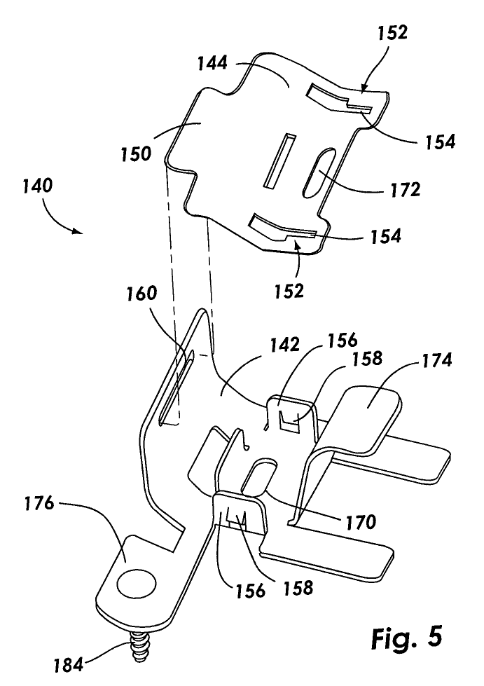

Referring now to FIG. 5, a different embodiment of the present invention is illustrated. FIG. 5 is a perspective view of a mounting bracket 140 that may be used to attach a curtain airbag 12 (shown in FIG. 3) to a vehicle interior 10 (shown in FIG. 3). As can be seen in FIG. 5, most of the components and elements of mounting bracket 140 are similar and/or equivalent to the components and elements that are found in the embodiment described above.

The mounting bracket 140 comprises a base bracket 142 and a retaining clip 144. The retaining clip 144 is attachable to the base bracket 142 and includes at least one inserting tab 150 and at least one receiving portion 152. Preferably, the receiving portion 152 comprises one or more slits 154 that are sized and designed such that a portion of the base bracket 142 may pass through and/or engage the slits 154.

As with the embodiment described above, the base bracket 142 includes one or more connecting tabs 156 that are constructed to engage the receiving portion 152. More specifically, the connecting tabs 156 are constructed such that they may engage the receiving portion 152 by being inserted and/or passed through the slits 154. One or more locking barbs 158 may additionally be added to the connecting tabs 156. Preferably, the locking barbs 158 are constructed such that if the connecting tabs 156 pass through the slits 154, the locking barbs 158 will engage the retaining clip 144 and prevent the connecting tabs 156 from withdrawing from the slits 154.

At least one aperture 160 is also added to the base bracket 142. The aperture 160 is an opening or hole in the base bracket 142 that is constructed and sized to receive the inserting tab 150. Preferably, this is accomplished by configuring the aperture 160 such that the inserting tab 150 may be inserted and/or interlocked with the aperture 160.

Like the previous embodiment, the mounting bracket 140 is constructed such that it is capable of retaining a curtain airbag 12 having a manifold 30 (shown in FIG. 3). More specifically, the mounting bracket 140 is constructed such that when the retaining clip 144 is attached to the base bracket 142, the mounting bracket 140 retains all or a portion of a manifold 30 between the base bracket 142 and the retaining clip 144.

The mounting bracket 140 may additionally comprise a first hole 170 and a second hole 172. The first hole 170 is added to the base bracket 142 and the second hole 172 is added to the retaining clip 144. Preferably, the first hole 170 and the second hole 172 are sized such that a fastener 46 (shown in FIG. 3) may pass through the first hole 170 and the second hole 172. One or more shape maintaining tabs 174 designed to hold the curtain airbag 12 in a rolled or folded configuration may also be added.

A mounting portion 176 may additionally be added to the base bracket 142. However, unlike the embodiment depicted in FIGS. 1-3, the mounting portion 176 comprises a pushpin 184 that extends rearwards of the first hole 176 and is designed to engage the opening 80 (shown in FIG. 3). Of course, other structures, including hooks, T-shaped tabs, fasteners and the like may also be used as the mounting portion 176.

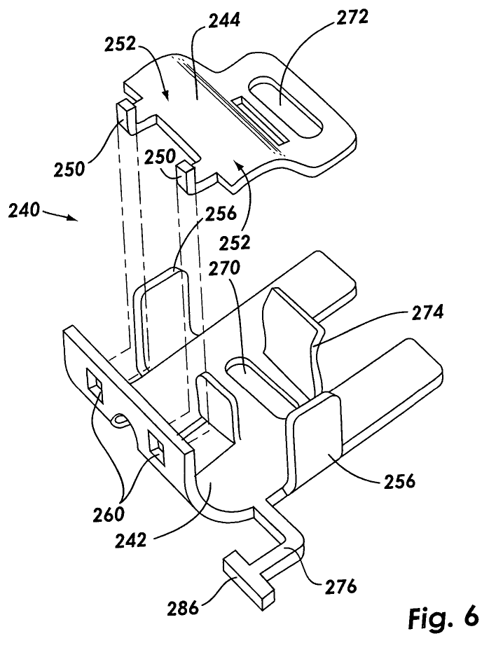

Referring now to FIG. 6, a further embodiment of the present invention is depicted. FIG. 6 is a perspective view of a mounting bracket 240 for attaching a curtain airbag 12 (shown in FIG. 3) to a vehicle interior 10 (shown in FIG. 3). As can be seen in FIG. 6, most of the components and elements of mounting bracket 240 are similar and/or equivalent to the components and elements that are found in the embodiments described above.

The mounting bracket 240 comprises a base bracket 242 and a retaining clip 244. The retaining clip 244 is attachable to the base bracket 242 and includes one or more inserting tabs 250. In FIG. 6, two inserting tabs 250 are illustrated. Additionally, the retaining clip 244 also includes at least one receiving portion 252. However, unlike the previous embodiments, the receiving portion 252 does not comprise one or more slits. Rather, the receiving portion 252 is a surface of the retaining clip 244 that is designed and sized to receive and/or hold a portion of the base bracket 242.

The base bracket 242 includes one or more connecting tabs 256. The connecting tabs 256 are designed to engage the receiving portion 252. Preferably, this is accomplished by constructing the connecting tabs 256 such that they may be folded over all or a portion of the receiving portion 252.

One or more apertures 260 are also added to the base bracket 242. As seen in FIG. 6, two apertures 260 have been added. The apertures 260 are openings or holes in the base bracket 242 that are designed to receive the inserting tabs 250. Preferably, this is accomplished by configuring the apertures 260 such that the inserting tabs 250 may be inserted and/or interlocked with the apertures 260.

Like the embodiments described above, the mounting bracket 240 is constructed such that it is capable of retaining a curtain airbag 12 having a manifold 30 (shown in FIG. 3). More specifically, the mounting bracket 240 is constructed such that when the retaining clip 244 is attached to the base bracket 242, the mounting bracket 240 retains all or a portion of a manifold 30 between the base bracket 242 and the retaining clip 244.

The mounting bracket 240 may additionally comprise a first hole 270 and a second hole 272. The first hole 270 is added to the base bracket 242 and the second hole 272 is added to the retaining clip 244. Preferably, the first hole 270 and the second hole 272 are sized such that a fastener 46 (shown in FIG. 3) may pass through the first hole 270 and the second hole 272. One or more shape maintaining tabs 274 designed to hold the curtain airbag 12 in a rolled or folded configuration may also be added.

A mounting portion 276 may additionally be added to the base bracket 242. However, unlike the embodiments depicted above, the mounting portion 276 does not comprise a pushpin or a hook. Rather, the mounting portion 276 comprises a T-shaped tab 286 that extends rearwards of the first hole 270 and is sized such that it may engage and/or be inserted into the opening 80 (shown in FIG. 3).

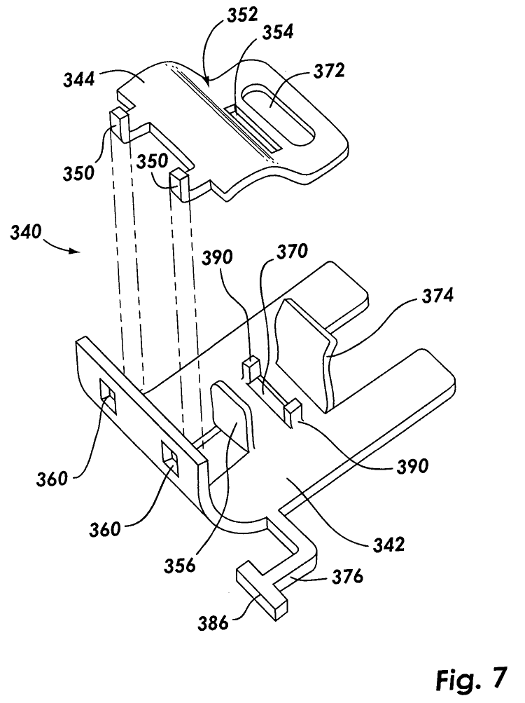

Referring now to FIG. 7, yet another embodiment of the present invention is depicted. FIG. 7 is a perspective view of a mounting bracket 340 for attaching a curtain airbag 12 (shown in FIG. 3) to a vehicle interior 10 (shown in FIG. 3). As can be seen in FIG. 7, most of the components and elements of mounting bracket 340 are similar and/or equivalent to the components and elements that are found in the embodiments described above.

The mounting bracket 340 comprises a base bracket 342 and a retaining clip 344. The retaining clip 344 is attachable to the base bracket 342 and includes one or more inserting tabs 350. In FIG. 7, two inserting tabs 350 have been added. Additionally, the retaining clip 344 also includes at least one receiving portion 352. Preferably, the receiving portion 352 comprises a slit 354. More than one slit 354 may also be used. The slit 354 is sized and designed such that a portion of the base bracket 342 may pass through and/or engage the slits 354.

As with the previous embodiments, the base bracket 342 includes one or more connecting tabs 356. In FIG. 7, only one connecting tab 356 is illustrated. The connecting tab 356 is designed to engage the receiving portion 352. Preferably, this is accomplished by constructing the connecting tab 356 such that it may pass through and/or engage the slit 354.

One or more apertures 360 are also added to the base bracket 342. As seen in FIG. 7, two apertures 360 have been added. The apertures 360 are openings or holes in the base bracket 442 that are designed to receive the inserting tabs 350. Preferably, this is accomplished by configuring the apertures 360 such that the inserting tabs 350 may be inserted and/or interlocked with the apertures 360.

Like the previous embodiments, the mounting bracket 340 is constructed such that it is capable of retaining a curtain airbag 12 having a manifold 30 (shown in FIG. 3). More specifically, the mounting bracket 340 is constructed such that when the retaining clip 344 is attached to the base bracket 342, the mounting bracket 340 retains all or a portion of a manifold 30 between the base bracket 342 and the retaining clip 344.

The mounting bracket 340 may additionally comprise a first hole 370 and a second hole 372. The first hole 370 is added to the base bracket 342 and the second hole 372 is added to the retaining clip 344. Preferably, the first hole 370 and the second hole 372 are sized such that a fastener 46 (shown in FIG. 3) may pass through the first hole 370 and the second hole 372. One or more shape maintaining tabs 374 designed to hold the curtain airbag 12 in a rolled or folded configuration may also be added.

A mounting portion 376 may additionally be added to the base bracket 342. More than one mounting portion 376 may also be used. Like the embodiment illustrated in FIG. 6, the mounting portion 376 shown in FIG. 7 comprises a T-shaped tab 386 that extends rearwards of the first hole 370. Of course, other structures, including pushpins, fasteners, and hooks, may also be used as the mounting portion 376.

The base bracket 342 may further comprise a folding tab 390 that is positioned adjacent to the first hole 370. More than one folding tab 390 may also be used. The folding tabs 390 are extensions or flaps that extend away from the first hole 370 and are constructed such that when the retaining clip 344 is attached to the base bracket 342, the folding tabs 390 may be engage and/or be folded over all or a portion of the retaining clip 344.

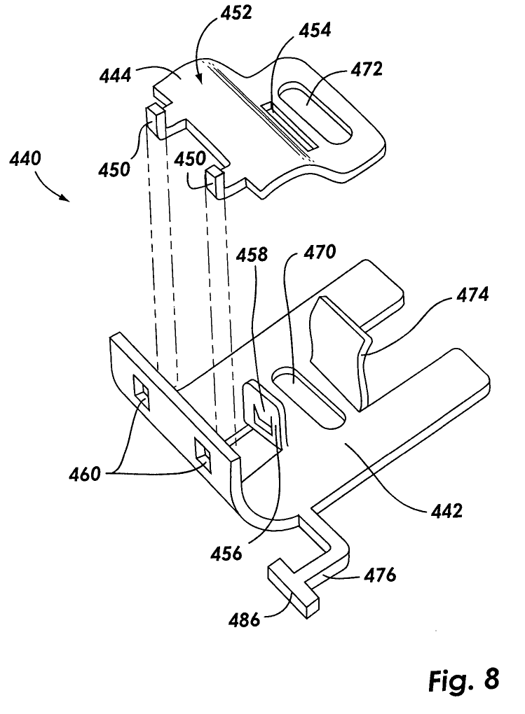

Referring now to FIG. 8, another embodiment of the present invention is depicted. FIG. 8 is a perspective view of a mounting bracket 440 for attaching a curtain airbag 12 (shown in FIG. 3) to a vehicle interior 10 (shown in FIG. 3). As can be seen in FIG. 8, most of the components and elements of mounting bracket 440 are similar and/or equivalent to the components and elements that are found in the embodiments described above.

The mounting bracket 440 comprises a base bracket 442 and a retaining clip 444. The retaining clip 444 is attachable to the base bracket 442 and includes one or more inserting tabs 450. In FIG. 8, two inserting tabs 450 have been added. Additionally, the retaining clip 444 also includes at least one receiving portion 452. Preferably, the receiving portion 452 comprises a slit 454. More than one slit 454 may also be used. The slit 454 is sized and designed such that a portion of the base bracket 442 may pass through and/or engage the slits 454.

As with the previous embodiments, the base bracket 442 includes one or more connecting tabs 456. In FIG. 8, only one connecting tab 456 is illustrated. The connecting tab 456 is designed to engage the receiving portion 452. Preferably, this is accomplished by constructing the connecting tab 456 such that it may pass through and/or engage the slit 454. One or more locking barbs 458 may additionally be added to the connecting tab 456. Preferably, the locking barbs 458 are constructed such that if the connecting tab 456 passes through the slits 454, the locking barbs 458 will engage the retaining clip 444 and prevent the connecting tabs 456 from withdrawing from the slits 454.

One or more apertures 460 are also added to the base bracket 442. As seen in FIG. 8, two apertures 460 have been added. The apertures 460 are openings or holes in the base bracket 442 that are designed to receive the inserting tabs 450. Preferably, this is accomplished by configuring the apertures 460 such that the inserting tabs 450 may be inserted and/or interlocked with the apertures 460.

Like the previous embodiments, the mounting bracket 440 is constructed such that it is capable of retaining a curtain airbag 12 having a manifold 30 (shown in FIG. 3). More specifically, the mounting bracket 440 is constructed such that when the retaining clip 444 is attached to the base bracket 442, the mounting bracket 440 retains all or a portion of a manifold 30 between the base bracket 442 and the retaining clip 444.

The mounting bracket 440 may additionally comprise a first hole 470 and a second hole 472. The first hole 470 is added to the base bracket 442 and the second hole 472 is added to the retaining clip 444. Preferably, the first hole 470 and the second hole 472 are sized such that a fastener 46 (shown in FIG. 3) may pass through the first hole 470 and the second hole 472. One or more shape maintaining tabs 474 designed to hold the curtain airbag 12 in a rolled or folded configuration may also be added.

A mounting portion 476 may additionally be added to the base bracket 442. More than one mounting portion 476 may also be used. Like the embodiments illustrated in FIGS. 6 and 7, the mounting portion 476 shown in FIG. 8 comprises a T-shaped tab 486 that extends rearwards of the first hole 470. Of course, other structures, including pushpins, fasteners, and hooks, may also be used as the mounting portion 476.

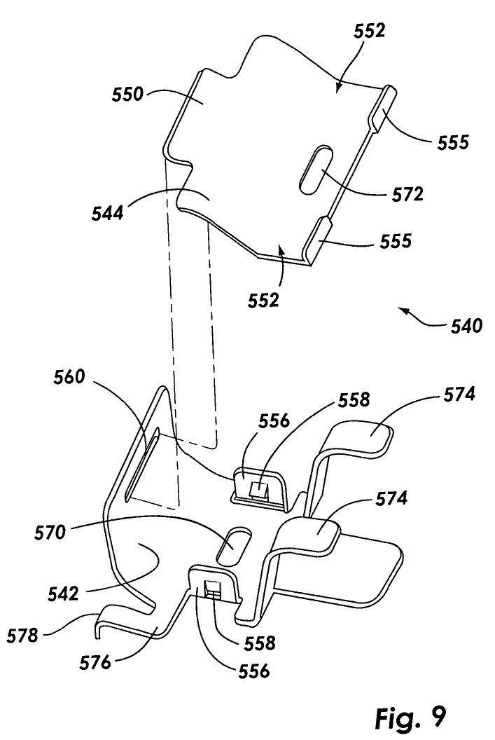

Referring now to FIG. 9, a yet further embodiment of the present invention is depicted. FIG. 9 is a perspective view of a mounting bracket 540 for attaching a curtain airbag 12 (shown in FIG. 3) to a vehicle interior 10 (shown in FIG. 3). As can be seen in FIG. 9, most of the components and elements of mounting bracket 540 are similar and/or equivalent to the components and elements that are found in the embodiments described above.

The mounting bracket 540 comprises a base bracket 542 and a retaining clip 544. The retaining clip 544 is attachable to the base bracket 542 and includes one or more inserting tabs 550. In FIG. 9, only one inserting tab 550 is illustrated. Additionally, the retaining clip 544 also includes at least one receiving portion 552. The receiving portion 552 is designed such that it may receive and/or engage a portion of the base bracket 542. One or more legs 555 may also be added to the retaining clip 544.

As with the previous embodiments, the base bracket 542 includes one or more connecting tabs 556. In FIG. 9, two connecting tabs 556 are depicted. The connecting tabs 556 are designed to engage the receiving portion 552. More specifically, the connecting tabs 556 are designed such that when the retaining clip 544 is attached to the base bracket 542, the receiving portion 552 will fit between the connecting tabs 556.

One or more locking barbs 558 may also be added to the connecting tabs 556. Unlikely the previous embodiments, the locking barbs 558 extend inwardly from the connecting tabs 556. Preferably, the locking barbs 558 are constructed such that if the retaining clip 544 is attached to the base bracket 542, the locking barbs 558 will hold the receiving portion 552 between the connecting tabs 556.

The base bracket 542 also includes one or more apertures 560. The apertures 560 are openings or holes in the base bracket 542 that are designed to receive the inserting tabs 550. Preferably, this is accomplished by configuring the apertures 560 such that the inserting tabs 550 may be inserted and/or interlocked with the apertures 560.

Like the previous embodiments, the mounting bracket 540 is constructed such that it is capable of retaining a curtain airbag 12 having a manifold 30 (shown in FIG. 3). More specifically, the mounting bracket 540 is constructed such that when the retaining clip 544 is attached to the base bracket 542, the mounting bracket 540 retains all or a portion of a manifold 30 between the base bracket 542 and the retaining clip 544.

The mounting bracket 540 may additionally comprise a first hole 570 and a second hole 572. The first hole 570 is added to the base bracket 542 and the second hole 572 is added to the retaining clip 544. Preferably, the first hole 570 and the second hole 572 are sized such that a fastener 46 (shown in FIG. 3) may pass through the first hole 570 and the second hole 572. One or more shape maintaining tabs 574 designed to hold the curtain airbag 12 in a rolled or folded configuration may also be added.

A mounting portion 576 may additionally be added to the base bracket 542. More than one mounting portion 576 may also be used. Like the embodiments illustrated in FIG. 2, the mounting portion 576 comprises a hook 578 that extends rearwards of the first hole 570. Of course, other structures, including pushpins, fasteners, and hooks, may also be used as the mounting portion 576.

In summary, the present invention provides a novel mounting bracket that addresses and/or solves many of the limitations and problems associated with previously known mounting brackets. The mounting bracket of the present invention is designed such that it may be used to mount an airbag having a manifold to a vehicle interior. More specifically, the mounting bracket comprises a retaining clip and a base bracket and is constructed such that when the retaining clip is attached to the base bracket, the manifold is held between the base bracket and the retaining clip.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A mounting bracket for attaching an inflatable curtain having a manifold to a vehicle interior comprising:
a base bracket comprising at least one aperture and at least one connecting tab; and
a retaining clip attachable to the base bracket, the retaining clip comprising at least one receiving portion and at least one inserting tab.

2. A mounting bracket as in claim 1 wherein the mounting bracket retains the manifold between the base bracket and the clip.

3. A mounting bracket as in claim 1 wherein the aperture is sized to receive the inserting tab.

4. A mounting bracket as in claim 1 wherein the connecting tab is constructed to engage the receiving portion.

5. A mounting bracket as in claim 1 wherein the receiving portion comprises a slit.

6. A mounting bracket as in claim 5 wherein the slit is sized to receive the connecting tab.

7. A mounting bracket as in claim 4 wherein the connecting tab is shaped to fold over the receiving portion.

8. A mounting bracket as in claim 1 wherein the connecting tab includes a locking barb.

9. A mounting bracket as in claim 8 wherein the locking barb extends outwardly from the connecting tab.

10. A mounting bracket as in claim 8 wherein the locking barb extends inboard from the connecting tab.

11. A mounting bracket as in claim 1 wherein the base bracket further comprises a first hole and the retaining clip further comprises a second hole.

12. A mounting bracket as in claim 11 wherein the first hole and the second hole are sized to receive a fastener.

13. A mounting bracket as in claim 1 wherein the mounting bracket is made of steel.

14. A mounting bracket as in claim 1 wherein the base bracket further comprises a mounting portion designed to engage an opening on the vehicle interior.

15. A mounting bracket as in claim 14 wherein the mounting portion comprises a T-shaped tab.

16. A mounting bracket as in claim 14 wherein the mounting portion comprises a pushpin.

17. A mounting bracket as in claim 14 wherein the mounting portion comprises a hook.

18. A mounting bracket as in claim 1 wherein the base bracket further comprises a shape-maintaining tab.

19. A mounting bracket as in claim 1 wherein the mounting bracket is attachable to a secondary bracket.

20. A mounting bracket as in claim 1 wherein the base bracket further comprises at least one folding tab that is constructed to fold over the retaining clip.

21. A mounting bracket as in claim 1 wherein the retaining clip comprises one or more legs.

22. A mounting bracket for attaching an inflatable curtain having a manifold to a vehicle interior comprising:
a base bracket; and
a retaining clip that attaches to the base bracket, the mounting bracket constructed such that when the retaining clip is attached to the base bracket, the manifold is held between the retaining clip and the base bracket.

23. A mounting bracket as in claim 19 wherein the base bracket comprises at least one aperture and at least one connecting tab and the retaining clip comprises at least one receiving portion and at least one inserting tab.

24. A mounting bracket as in claim 23 wherein the aperture is sized to receive the inserting tab.

25. A mounting bracket as in claim 23 wherein the connecting tab is constructed to engage the receiving portion.

26. A mounting bracket as in claim 23 wherein the receiving portion comprises a slit.

27. A mounting bracket as in claim 26 wherein the slit is sized to receive the connecting tab.

28. A mounting bracket as in claim 23 wherein the connecting tab is shaped to fold over the receiving portion.

29. A mounting bracket as in claim 23 wherein the connecting tab includes a locking barb.

30. A mounting bracket as in claim 22 wherein the base bracket further comprises a first hole and the retaining clip further comprises a second hole.

31. A mounting bracket as in claim 30 wherein the first hole and the second hole are sized to receive a fastener.

32. A mounting bracket as in claim 22 wherein the base bracket further comprises a mounting portion designed to engage an opening on the vehicle interior.

33. A mounting bracket as in claim 32 wherein the mounting portion comprises a T-shaped tab.

34. A mounting bracket as in claim 32 wherein the mounting portion comprises a push pin.

35. A mounting bracket as in claim 32 wherein the mounting portion comprises a hook.

36. A mounting bracket as in claim 22 wherein the base bracket further comprises a shape-maintaining tab.

37. A mounting bracket as in claim 22 wherein the mounting bracket is attachable to a secondary bracket.

38. A mounting bracket as in claim 22 wherein the base bracket further comprises at least one folding tab that are constructed to fold over the retaining clip.

39. A mounting bracket as in claim 22 wherein the retaining clip comprises one or more legs.

40. A method for attaching an inflatable curtain having a manifold to a vehicle comprising:
obtaining a mounting bracket comprising a base bracket having at least one aperture and at least one connecting tab, and a retaining clip that attaches to the base bracket, the retaining clip having at least one receiving portion and at least one inserting tab;
retaining the airbag within the mounting bracket; and
attaching the mounting bracket with the retained manifold to the vehicle.

41. A method as in claim 40 wherein the base bracket further comprises a mounting portion designed to engage a hole in a vehicle.

42. A method as in claim 41 wherein the method further comprises the step of positioning the mounting bracket and the retained airbag on the vehicle interior.

43. A method as in claim 42 wherein the positioning step comprises inserting the mounting portion into an opening on the vehicle interior.

44. A method as in claim 40 wherein attaching step comprises attaching the mounting bracket to the vehicle via a fastener that passes through the mounting bracket.

45. A method as in claim 40 wherein the inserting tab is inserted into the aperture.

46. A method as in claim 40 wherein the connecting tab engages the receiving portion.
